(19) United States
(12) Patent Application Publication
(10) Pub. No.: US 2014/0158868 A1
(43) Pub. Date: Jun. 12, 2014

(54) Rotatable Viewing Apparatuses and Methods of Making and Using the Same

(71) Applicant: Guillermo Jorge Keller, Santa Clarita, CA (US)

(72) Inventor: Guillermo Jorge Keller, Santa Clarita, CA (US)

(21) Appl. No.: 13/801,428

(22) Filed: Mar. 13, 2013

Related U.S. Application Data
(60) Provisional application No. 61/736,457, filed on Dec. 12, 2012.

(51) Int. Cl. G02B 27/02; G02B 7/182; G02B 7/18

(52) U.S. Cl. CPC G02B 27/022; G02B 7/1805; G02B 7/1821
USPC 250/216; 359/876; 359/860; 359/833; 29/428

(57) ABSTRACT

Methods, systems and apparatuses for rotational viewing systems for optical and/or other measuring equipment are disclosed. The rotational viewing device includes a housing having an interface end opposite a viewing end. The housing has one or more bends between the interface end and the viewing end, an internal mirror, and one or more rotatable joints or connections allowing at least part of the housing to be rotated in a plane parallel or orthogonal to an optical axis of an apparatus to which the viewing device interfaces at the interface end. The rotational viewing device also includes an eyepiece, located at or near the viewing end.

### RELATED APPLICATIONS

This application claims the benefit of U.S. Provisional Patent Application No. 61/736,457, filed Dec. 12, 2012 (Attorney Docket No. CRI-001-PR), which is incorporated herein by reference in its entirety.

### FIELD OF THE INVENTION

The present invention generally relates to the field of viewing systems. More specifically, embodiments of the present invention pertain to viewing systems for optical and/or other measuring equipment, and methods of making and using the same.

### DISCUSSION OF THE BACKGROUND

Optical measuring instruments are commonly used in scientific research, quality control or production measurement. Examples of optical measuring instruments include photometers, colorimeters and spectroradiometers. Optical measuring instruments can be used for color matching, colorimetry, spectrophotometry, and quality control (e.g., during the manufacture of CRT, LCD and LED displays), etc.

Optical measuring instruments may incorporate a fixed reflex viewing system, where it is important to see exactly the object at which the optical measuring instrument is looking. Reflex viewing systems have a single optical path that allows the user to have the same optical view as the instrument. Further, in such a viewing system, the image is erect, and not reversed as in a “mirror image.” For example, a single lens reflex camera generally comprises a mirror and a prism, and allows the viewer to see the object directly through the lens, and thereby view the image that will be captured by the camera. Frequently in research and online production measurement setups, it is not possible for the observer to be directly behind the apparatus, as in the single lens reflex viewing system example.

A Pritchard optical system (see, e.g., U.S. Pat. Nos. 3,813,172 and 3,799,680) may be used in conventional optical measuring instruments such as a colorimeter. Light and/or an image pass through an objective lens of the measuring instrument and strike a mirror with an aperture formed therein. In a conventional Pritchard optical system, a portion of the light and/or image being processed and/or measured passes through the aperture of the mirror and is further processed and/or measured by the measuring instrument. Another portion of the light and/or image that reflects from the mirror passes into the viewing portion of the measuring instrument (e.g., an eyepiece).

The Pritchard optical system has been utilized for several decades and is typically used in optical measuring instruments. However, the eyepiece is in a fixed location on the instrument, and is otherwise non-movable. The viewer must align himself or herself with the angle of the viewing optics to use the eyepiece. This can be disadvantageous in situations where the eyepiece is in an inaccessible and/or uncomfortable spot for the viewer. For example, the viewer may be doing work on the right side of the instrument, but has to repeatedly move over to the left side of the measuring instrument to look through the eyepiece or viewing system. Alternatively, the limitations and/or requirements of the measuring/testing setup and/or the layout of the work area may make using the viewing system of the measuring instrument uncomfortable and/or inconvenient. This can be an issue in research and online production measurement setups where it is not possible for the viewer to be directly behind the apparatus (e.g., a reflex viewer).

This “Background” section is provided for background information only. The statements in this “Background” are not an admission that the subject matter disclosed in this “Background” section constitutes prior art to the present disclosure, and no part of this “Background” section may be used as an admission that any part of this application, including this “Background” section, constitutes prior art to the present disclosure.

### SUMMARY OF INVENTION

Embodiments of the present invention advantageously provide a moveable and/or rotatable viewing system for measuring instruments, such as optical measuring instruments (e.g., a photometer, colorimeter, spectroradiometer, etc.).

In one aspect, the present invention provides a rotatable viewing device comprising a housing having an interface end opposite a viewing end, and configured to have one or more bends between the first and second ends. The rotatable viewing device further comprises a mirror in the housing, one or more rotatable joints or connections allowing at least part of the housing to be rotated in a plane parallel or orthogonal to an optical axis of an apparatus to which the viewing device interfaces at the interface end, and an eyepiece located at or near the viewing end.

In another aspect, the present invention provides a method of making a rotatable viewing device comprising forming a housing, attaching a mirror inside the housing at or near a bend in the housing, and connecting an eyepiece to the housing. The housing has an interface end, a viewing end, and one or more bends therein. The rotatable viewing device includes one or more joints or connections configured to allow the housing to rotate in a plane parallel and/or perpendicular to an optical axis of the apparatus to which the viewing device interfaces. The eyepiece may be permanently or detachably connected to the viewing end of the housing. The method further comprises aligning the optical components of the viewing device to allow light entering the interface end of the housing to exit at the viewing end.

In another aspect, the present invention provides a method of using the viewing device that comprises aligning an optical measuring instrument comprising the viewing device with an object, rotating the viewing device to a position enabling the user to view the object using the viewing device, and taking one or more measurements of the object using the optical measuring instrument.

These and other advantages of the present invention will become readily apparent from the detailed description of various embodiments below.

### BRIEF DESCRIPTION OF THE DRAWINGS

FIG. 1A is a cut-away view of an exemplary horizontally rotational viewing apparatus according to one embodiment of the present invention.

FIG. 1B is a top-down view of an exemplary horizontally rotational viewing apparatus according to one embodiment of the present invention.

FIG. 2A is a cut-away view of an exemplary vertically rotational viewing apparatus according to another embodiment of the present invention.

FIG. 2B is a front view of an exemplary vertically rotational viewing apparatus according to one embodiment of the present invention.

FIG. 3 is a cut-away view of an embodiment of a viewing apparatus equipped with a shutter.

FIG. 4 is a flow chart showing an exemplary method for making a rotational viewing apparatus according to embodiments of the present invention.

FIG. 5 is a flow chart showing an exemplary method for using a rotational viewing device according to embodiments of the present invention.

### DETAILED DESCRIPTION

Reference will now be made in detail to various embodiments of the invention, examples of which are illustrated in the accompanying drawings. While the invention will be described in conjunction with the following embodiments, it will be understood that the descriptions are not intended to limit the invention to these embodiments. On the contrary, the invention is intended to cover alternatives, modifications and equivalents that may be included within the spirit and scope of the invention. Furthermore, in the following detailed description, numerous specific details are set forth in order to provide a thorough understanding of the present invention. However, it will be readily apparent to one skilled in the art that the present invention may be practiced without these specific details. In other instances, well-known methods, procedures, components, and circuits have not been described in detail so as not to unnecessarily obscure aspects of the present invention.

For the sake of convenience and simplicity, the terms “eyepiece,” “viewfinder” and “viewing system” are generally used interchangeably herein, but are generally given their art-recognized meanings. Also, for convenience and simplicity, the terms “measuring instrument” and “optical measuring instrument” may be used interchangeably, but these terms are also generally given their art-recognized meanings. Further, for convenience and simplicity, the terms “optical axis,” “measurement axis,” “travel” and “path” may be used interchangeably, but these terms are also generally given their art-recognized meanings.

The present invention relates to a horizontally rotational viewing apparatus, a vertically rotational viewing apparatus, and methods of making and using the same. Embodiments of the present invention can advantageously provide for a viewing system that can freely rotate to enable observation of an image or object under inspection from substantially any angle. Further, embodiments of the present invention can advantageously provide for the viewing system to rotate in the horizontal plane parallel to the measurement axis. Additional embodiments of the present invention can advantageously provide for the viewing system to rotate in a vertical plane perpendicular to the measurement axis.

These and other advantages of the present invention will become readily apparent from the detailed description of various embodiments below.

A First Exemplary Viewing System

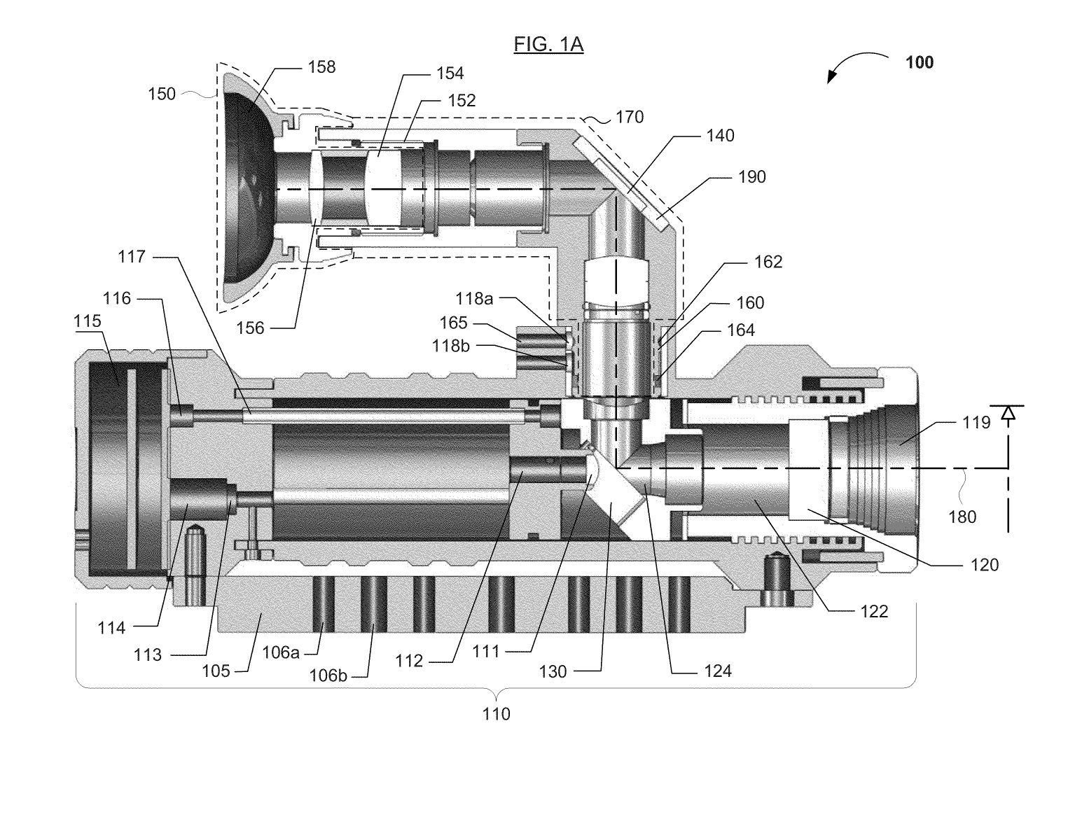

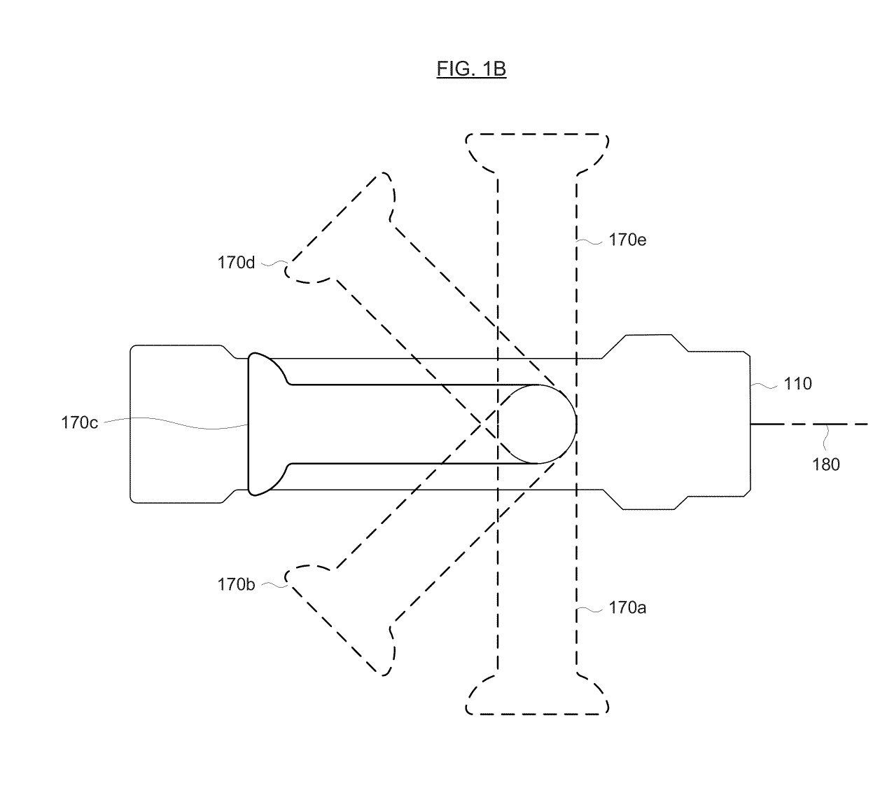

In one aspect, the present invention relates to a viewing system comprising one or more angled mirrors (e.g., a 45° mirror), one or more rotating joints, and an eyepiece. FIG. 1A illustrates an exemplary viewing system 100 coupled to optical measuring instrument 110. While FIG. 1A illustrates a general viewing system, embodiments of the present invention should not be limited to the exemplary configuration of FIG. 1A. Because viewing system 100 can rotate in a plane parallel to the optical axis of optical measuring instrument 110 (e.g., a horizontal plane above the optical measuring instrument 110), it may be considered a “horizontal” viewing system for use with the optical measuring instrument 110 (e.g., a colorimeter).

Optical measuring instrument 110 can be any optical measuring instrument that may utilize a viewing system. For example, optical measuring instrument 110 can be any device that measures the photometric, colorimetric and/or spectral characteristics of an object. Optical measuring instrument 110 may contain a focusing and/or objective lens (hereinafter, “focusing lens”) 120 and an angled mirror 130. The angled mirror 130 has at least one aperture or opening. However, angled mirror 130 may have multiple apertures and may also be rotatable (e.g., like a Pritchard optical system). Light from the object being measured or otherwise processed travels through focusing lens 120 and at least one aperture in angled mirror 130 and passes on to the other sections of optical measuring instrument 110. Optical measuring instrument 110 may comprise a coupler lens 111, an optical fiber 112, one or more optical filters 113, one or more photodiodes 114, electronic circuitry 115 configured to process information from the photodiode(s) 114, mounting hardware 116, one or more stand-offs 117, one or more soft stop(s) 118a-b, a lens (e.g., objective lens) 120, a lens hood 119, a hollow 122, and/or an F-stop 124. Optical measuring instrument 110 may also comprise an instrument mounting platform 105. In a further embodiment, instrument mounting platform 105 may have one or more holes (e.g., holes 106a-b) drilled and/or formed therein for facile mounting of the instrument 110 onto a (movable) surface or platform, for example. Further, angled mirror 130 may have any angle that allows for some light to pass through the aperture to the optical measuring instrument 110 and some light to reflect to the viewing system 100. In a preferred embodiment, the angled mirror 130 has a 45° angle relative to the optical axis 180 of the optical measuring instrument 110.

Viewing system 100 has an interface end (e.g., a light receiving end) and a viewing end (e.g., a light output or exit end). Viewing system 100 has a cavity between the interface end and viewing end for holding optics, such as mirrors, lenses, prisms, and/or an eyepiece. Viewing system 100 may have any shape capable of holding the optics and transmitting light from the interface end to the viewing end. In one embodiment, the housing and/or cavity has a substantially cylindrical shape. The overall shape of viewing system 100 can generally be the same as or different from the shape of the cavity. For example, viewing system 100 can be generally cylindrical, rectangular or oval. Further, the body between the interface end and a viewing end of viewing system 100 is angled (or bent) in at least one location. In another embodiment, the body between the interface end and a viewing end of viewing system 100 has a bend with an angle of 90°. The body of viewing system 100 can comprise any material, or combination of materials, capable of housing optics. For example, viewing system 100 may comprise one or more tubes, plates, rings, wires, etc. of metal, plastic, ceramic, etc., or a combination thereof.

Rotating joint 160 allows for the upper section 170 of viewing system 100 to rotate any number of degrees in a plane that is (i) parallel to the measurement axis 180 of optical measuring instrument 110 and (ii) perpendicular to the plane of the page. In one embodiment, the upper section 170 may rotate 360° in this plane. The ability to rotate the upper section 170 of viewing system 100 allows the viewer to view the object being measured from all sides of optical measuring instrument 110. Further, to facilitate positioning of the viewing system 100, the rotating joint 160 may have soft stops every 360°/n, where n is an integer of 2 or more (e.g., from 4 to 24, resulting in increments of 30°, 45°, or 90°, or other fixed value or angle between the rotational soft stops), relative to the optical axis 180. The soft stops may be in a fitting inside rotating joint 160. The soft stops may comprise one or more complementary notches and ridges or projections on opposed surfaces of rotating joint 160, or a notch-and-spring-loaded-bearing mechanism 118a-b and/or 162, etc. Pressure on bearing 118a can be adjusted through a spring between it and a screw or bolt in fitting/opening 165. Further, projection 118b can also be similarly adjusted. In another embodiment, the viewing system 100 may comprise a ring 164 (e.g., a “locking” ring) configured to releasably or permanently secure the upper section 170 to the optical measuring instrument 110. It should be noted that as viewing system 100 is rotated about the rotating joint 160, the image, as viewed though eyepiece 150, may change its orientation.

FIG. 1B illustrates various exemplary horizontally rotated positions 170a-e of the upper section 170 of viewing system 100 with respect to the optical measuring instrument 110. For example, position 170c may be the default position of the upper section 170 of viewing system 100 (e.g., at an angle of 0° with respect to the optical axis of the optical measuring instrument 110). The upper section 170 may be rotated 45° from the default position 170c to a soft stop at position 170b or position 170d. Further, the upper section 170 may be rotated another 45° from position 170b or position 170d (or 90° from the default position 170c) to a soft stop at position 170a or position 170e, respectively. While FIG. 1B shows exemplary positions of the upper section 170 at 45° (e.g., positions 170b and 170d) and 90° (e.g., positions 170a and 170e) from the default position 170c, it will be readily understood by those skilled in the art that rotations of the upper section 170 are not limited thereto, and the upper section 170 may be rotated any number of degrees relative to the default position.

Referring back to FIG. 1A, viewing system 100 further comprises angled mirror 140, one or more rotating joints (e.g., rotating joint 160), and eyepiece 150. In one embodiment, viewing system 100 can have an angle of 90°, such that a first section of viewing system 100 extends generally perpendicular to the optical axis 180 of optical measuring instrument 110, and a second section is generally parallel to the optical axis 180 of optical measuring instrument 110. Light from the object being measured and/or evaluated by the optical measuring instrument 110 reflects from angled mirror 130 to angled mirror 140, and then from angled mirror 140 to eyepiece 150 of viewing system 100. A viewer can thus look through the eyepiece 150 to view the object being measured by the optical measuring instrument 110.

Angled mirror 140 may be aligned with the optical axis of the light reflected from or by angled mirror 130. Angled mirror 140 is mounted or affixed at or near a bend in viewing system 100. In one embodiment, the angled mirror 140 may be mounted or attached on substrate 190 that serves as an exterior in the upper section 170, and the substrate 190 may be configured to fit in a space and/or opening in the upper section 170. Angled mirror 140 can be placed at any angle suitable to allow angled mirror 140 to be aligned with the optical axis of the light reflected off angled mirror 130 and eyepiece 150. In one embodiment, the angled mirror 140 is placed at or about a 45° angle to the optical axis 180 of the light reflected by angled mirror 130.

The eyepiece (or ocular lens) 150 can be any eyepiece that allows the viewer to view the object being measured by optical measuring instrument 110. Further, eyepiece 150 can comprise a barrel (e.g. 152 and one or more lenses 154 and/or groups of lenses. Eyepiece 150 may further comprise an eye lens 156. Eyepiece 150 may also comprise a cup 158 of any suitable shape and distance from the eye lens 156. In further embodiments, the eyepiece 150 may further comprise a diopter adjustment and/or aperture. In other embodiments, the eyepiece may have a diameter of 20 mm-30 mm. In still other embodiments, the one or more lenses may be concave, convex, and any combination thereof. In other embodiments, eyepiece 150 may comprise a mechanism for attaching a camera and/or computer display.

A Second Exemplary Viewing System

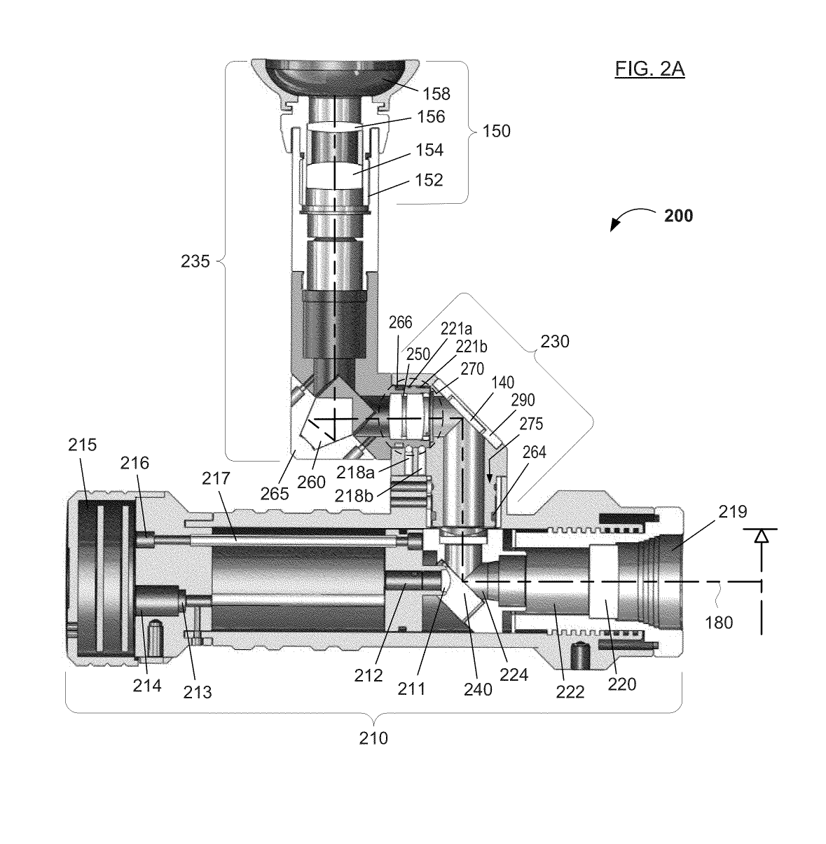

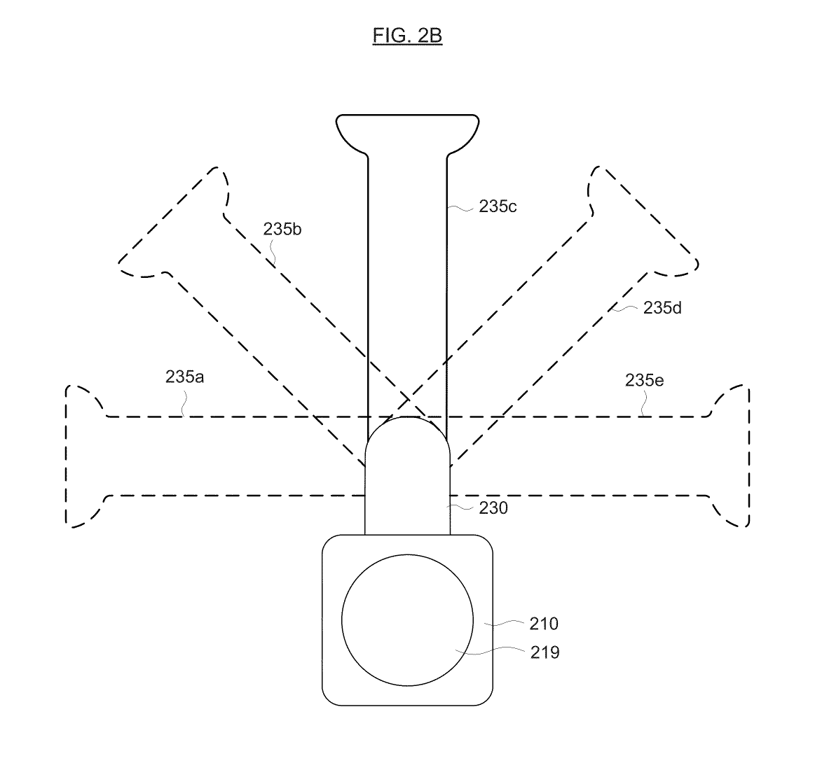

Referring now to FIG. 2A, another aspect of the present invention relates to a viewing system 200 that generally includes an angled mirror 140, a pentaprism 260, one or more rotating joints (e.g., rotating joint 270), and an eyepiece 150. In a further embodiment, viewing system 200 may have one or more lenses and/or groups of lenses (e.g., lens 250) between the angled mirror 140 and the pentaprism 260. Because viewing system 200 can rotate in a plane perpendicular to the optical axis of optical measuring instrument 210 (e.g., a vertical plane above the optical measuring instrument 210), it may be considered a “vertical” viewing system for use with the optical measuring instrument 210 (e.g., a colorimeter).

Similar to FIG. 1A, optical measuring instrument 210 in FIG. 2A can be any optical measuring instrument that utilizes a viewing system. For example, optical measuring instrument 210 can be any device that measures the photometric, colorimetric and/or spectral characteristics of an object. Optical measuring instrument 210 may contain focusing lens 220 and angled mirror 240. Angled mirror 240 has at least one aperture therein. Alternatively, angled mirror 240 may have multiple apertures, and may also be rotatable (e.g., like a Pritchard optical system). Light from the object being measured or otherwise processed travels through focusing lens 220 and at least one aperture in angled mirror 240 and passes on to the other sections of optical measuring instrument 210. Optical measuring instrument 210 may comprise a coupler lens 211, an optical fiber 212, one or more optical filters 213, one or more photodiodes 214, electronic circuitry 215 configured to process information from the photodiode(s) 214, mounting hardware 216, one or more stand-offs 217, a lens (e.g., objective lens) 220, a lens hood 219, a hollow 222, and/or an F-stop 224. Further, angled mirror 240 may have any angle that allows for some light to pass through the aperture to the optical measuring instrument 210 and some light to reflect to the viewing system 200. In one embodiment, the angled mirror 240 has a 45° angle with respect to the optical axis 180 of instrument 210.

Viewing system 200 has an interface end, proximal to the optical measuring instrument 210, and a viewing end, distal to the optical measuring instrument 210. Viewing system 200 has a cavity between the interface end and viewing end for holding optics, such as mirrors, lenses, prisms, and/or an eyepiece. Viewing system 200 may have any shape capable of holding the optics and transmitting light from the interface end to the viewing end. In one embodiment, the housing and/or cavity has a substantially cylindrical shape The overall shape of viewing system 200 can generally be the same as or different from the shape of the cavity. For example, viewing system 200 can be generally cylindrical, rectangular or oval. Further, the body between the interface end and a viewing end of viewing system 200 is angled (or bent) in at least one location. In one embodiment, the body between the interface end and a viewing end of viewing system 200 has a bend with an angle of 90°. The body of viewing system 200 can comprise any material, or combination of materials, capable of housing optics. For example, viewing system 200 may comprise one or more tubes, plates, rings, wires, etc. of metal, plastic, ceramic, etc., or a combination thereof.

In one embodiment, viewing system 200 comprises a first section 230, a second section 235 and a rotatable joint 270 between the first and second sections 230 and 235. The first section 230 of the body of viewing system 200 extends generally perpendicular to the optical axis 180 of optical measuring instrument 210. The second section 235 also extends generally perpendicular to the optical axis 180 of optical measuring instrument 210.

In one exemplary embodiment, angled mirror 140 is mounted or affixed in the first section 230, and a pentaprism 260 is mounted or affixed in the second section 235. Light from the object being measured and/or evaluated by the optical measuring instrument 210 reflects from angled mirror 240 towards the angled mirror 140, then from angled mirror 140 through an optional lens 250 into the pentaprism 260. The light continues from pentaprism 260 to the eyepiece 150 of the viewing system 200. A viewer can thus look through the eyepiece 150 to view the object being measured by the optical measuring instrument 210.

Angled mirror 140 may be aligned with the optical axis of the light reflected from and/or by angled mirror 240. Angled mirror 140 is mounted or affixed at or near where the first section 230 and the second section 235 meet in the body of viewing system 200. In one embodiment, the angled mirror 140 may be mounted or attached on substrate 290 that serves as an exterior in the first section 230 of viewing system 200, and the substrate 290 may be configured to fit in a space and/or opening in the upper section 230. In another embodiment, the viewing system comprises a third section (not shown) between the first section 230 and the second section 235, configured to separate the first and second sections 230 and 235 and/or facilitate a second (e.g., horizontal) degree of rotational freedom in the viewing apparatus 200. In a further embodiment, the third section may be substantially parallel to the measuring instrument. In further embodiments, the angled mirror 140 may be positioned at or about a location equidistance from pentaprism 260 and the interface end of the optical measuring instrument 210. Angled mirror 140 can be placed at any angle allowing angled mirror 140 to be aligned with the optical axis of the light reflected from angled mirror 240 (and optionally, from pentaprism 260). In one embodiment, the angled mirror 140 has a 45° angle with respect to the optical axis of light reflected by mirror 240.

In general, a pentaprism is a five-sided reflecting prism used to reflect a beam of light by a constant 90°. This reflection angle may result even if the entry beam is not at 90° to the face of the prism that it enters. In other embodiments, the pentaprism can be replaced with one or more mirrors. In further embodiments, the pentaprism can be replaced with a second mirror. Pentaprism 260 is mounted or affixed at or near a second bend in the body of viewing system 200. In one embodiment, the pentaprism 260 may be mounted or attached on substrate 265 that serves as an exterior in the second section 235 of viewing system 200, and the substrate 265 may be configured to fit in a space and/or opening in the second section 235. One face of pentaprism 260 is generally perpendicular to the optical axis of the light reflected from angled mirror 140, and a second face is generally perpendicular to the optical axis of eyepiece 150.

The eyepiece (or ocular lens) 150 can be any eyepiece that allows the viewer to view the object being measured by optical measuring instrument 210. Further, eyepiece 150 can comprise a barrel (e.g. 152 and one or more lenses 154 and/or groups of lenses. Eyepiece 150 may further comprise an eye lens 156. Eyepiece 150 may also comprise a cup 158 of any suitable shape and distance from the eye lens 156. In further embodiments, the eyepiece 150 may further comprise a diopter adjustment and/or aperture. In other embodiments, the eyepiece may have a diameter of 20 mm-30 mm. In still other embodiments, the one or more lenses may be concave, convex, and any combination thereof. In other embodiments, eyepiece 150 may comprise a mechanism for attaching a camera and/or computer display.

Rotating joint 270 allows for the upper section 235 of viewing system 200 to rotate a number of degrees in a plane that is perpendicular to the measuring instrument 210. In one embodiment, vertical viewing system 200 rotates up to about 270°. The ability to rotate upper section 235 of viewing system 200 allows the viewer to view the object being measured from different sides of optical measuring instrument 210. Further, the rotating joint 270 may have soft stops every 30°, 45° or 90° (or other fixed value or angle) relative to the optical axis 180 to facilitate positioning of viewing system 200. The soft stops may be located in a fitting inside 230. Further, the soft stops may comprise complementary notches 221a-b and ridges or projections 218a-b on opposing surfaces inside the rotatable joint 270, a similar notch-and-spring-loaded-bearing mechanism, etc. The observed image may rotate as viewing system 200 is rotated about rotating joint 270, but the image is not rotated or reversed when the image of the object being measured is observed with the eyepiece rotated +90° or −90° from the vertical position. In another embodiment, vertical viewing system 200 has a second rotating joint 275 in the same location as rotating joint 160 in the first exemplary viewing system (FIG. 1A).

FIG. 2B illustrates various exemplary vertical rotational positions 235a-e of the second section 235 of viewing system 200 about rotatable joint 270. For example, position 235c may be the default position of the upper section 235 of viewing system 200 (e.g., at an angle of 0° with respect to the optical axis of the optical measuring instrument 210). The upper section (e.g., upper section 235) may be rotated 45° from the default position 235c to position 235b or position 235d. Further, the upper section 235 may be rotated another 45° from position 235b or position 235d (or 90° from the default position 235c) to position 235a or position 235e. While FIG. 2B shows exemplary positions of the upper section 235 at 45° (e.g., positions 235b and 235d) and 90° (e.g., positions 235a and 235e) from the default position 235c, it will be readily understood by those skilled in the art that rotations of the upper section 235 are not limited thereto, and the upper section 235 may be rotated any number of degrees relative to the default position.

An Exemplary Shutter for a Viewing System

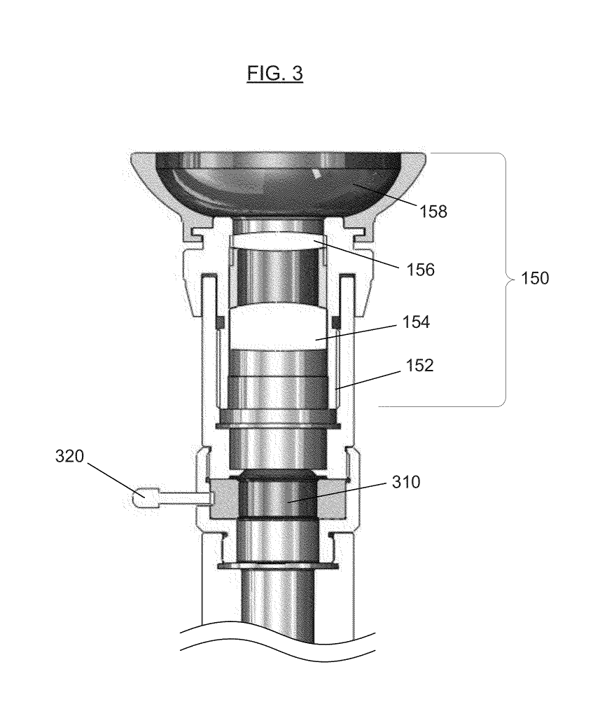

Referring now to FIG. 3, another aspect of the present invention relates to a rotatable viewing device that generally includes a shutter 310. For example, the viewing system 100 in FIG. 1 and/or the viewing system 200 in FIG. 200 may comprise shutter 310. In one embodiment, shutter 310 may be permanently or detachably mounted or placed between the eyepiece 150 and the interface end or a bend in the housing of the rotatable viewing system 170 (FIG. 1A). In another embodiment, shutter 310 may be permanently or detachably mounted or placed between the pentaprism 260 and the eyepiece 150 in the upper section 235 of the rotatable viewing system of FIG. 2A. Shutter 310 may comprise an aperture capable of opening or closing, and be configured to control the amount of light that passes through the viewing system 100 to eyepiece 150. Shutter 310 may further comprise a lever, knob, dial, or switch 320 configured to control the extent to which the aperture or the shutter 310 opens or closes.

An Exemplary Method of Making a Rotatable Viewing Device

The present invention further relates to method of making a rotatable viewing device. Specifically, the method of making a rotatable viewing device may comprise forming a housing comprising a plurality of elongated members and/or sections, including one or more bends between adjacent sections and one or more rotatable joints or connections, attaching or mounting a mirror inside the housing, and permanently or detachably connecting an eyepiece to the housing, wherein all components are aligned to allow light entering an interface end of the housing to exit at a viewing end of the housing. In one embodiment, the mirror and eyepiece comprise pre-assembled components.

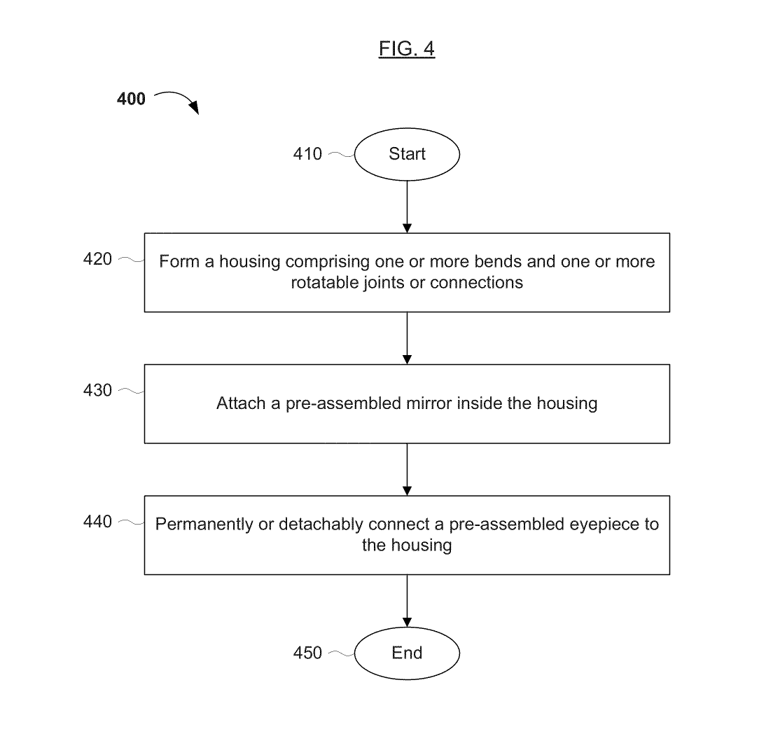

Flow chart 400 of FIG. 4 illustrates a method of making a viewing device according to the present invention. The method encompasses forming a housing having one or more bends and one or more rotatable joints or connections, attaching a mirror inside the housing, and permanently or detachably connecting an eyepiece to the housing, wherein all optical components are aligned to allow light entering an interface end of the housing to exit at a viewing end of the housing.

The method may begin at 410, and at 420, the method comprises forming a housing comprising one or more bends and one or more rotatable joints or connections. In a further embodiment, the housing may comprise one or more sections. In still further embodiments, the one or more sections, rotatable joints and/or connections may be connected using adhesives, welds, grooves and o-rings, screws, rivets, combinations thereof, etc. In still further embodiments, various parts of the housing may have complementary threads and grooves configured to connect to one or more other parts of the housing. In other embodiments, there may be one or more openings in the housing, in one or more sections and/or at one or more intersections of the one or more sections. In further embodiments, the one or more openings are configured to receive a mirror and/or pentaprism. In still further embodiments, the mirror(s) and/or pentaprism may be mounted or affixed onto a substrate configured to mate with or fit over and/or into the opening in the housing an adhesive, welds, a groove and O-ring fitting, screws, rivets, snap-on fittings, combinations thereof, etc.

In one embodiment, the housing comprises one bend and one rotatable joint. For example, referring to FIG. 1A, the housing may generally have the shape of the upper section 170 of viewing system 100, and the rotatable joint may be at an interface end of the housing. In another embodiment, the rotatable joint may be located at the interface between first and second sections of the housing. In such an embodiment, the housing may have two bends and one or more rotatable joints. For example, referring to FIG. 2A, the housing may generally have the shape of the first and second sections 230 and 235 of the viewing system 200.

In one embodiment, the housing is formed with a cavity having a cylindrical, rectangular or oval shape. In another embodiment, the housing is formed with one or more bend(s) having an angle of about 90°. In other or further embodiments, the housing includes one or more tubes, plates, rings, wires, etc. of metal, plastic, ceramic, etc., or a combination thereof. In yet other or further embodiments, the housing limits the amount of outside (e.g., external or extraneous) light that enters the viewing device, or substantially completely prevents external light from entering the viewing device.

At 430, a mirror is mounted or attached inside the housing. The mirror can be of any type and dimension capable of allowing or facilitating light entering the interface end of the housing to exit the viewing end of the housing. Alternatively, the mirror allows or facilitates light entering the interface end of the housing to exit an interface with a second section of the housing. In one embodiment, the mirror may be substantially flat. Alternatively, the mirror may be concave, convex, or otherwise shaped to focus the light from the optical measuring instrument to another location in the optical path (e.g., the eyepiece). The mirror may be mounted or affixed inside the housing an adhesive, rivets, screws, clips, etc. In a further embodiment, the mirror may be placed into a holder that is clipped, adhered, attached and/or otherwise mounted or affixed on or in the housing. In still further embodiments, the mirror may be mounted or affixed onto a substrate configured to mate or fit over and/or into an opening in the housing. In still further embodiments, the mirror may be mounted or attached into one section of the housing, and the sections subsequently connected to form the housing. In one such embodiment, the housing may comprise two pieces bisected along the optical axis, with substantially semi-cylindrical cavities therein. The mirror (and other optical components) may be mounted in one or the other semi-cylindrical cavity, and the two bisected pieces fastened or connected to each other after the optical components are securely mounted inside the housing cavity(ies). In another embodiment, the mirror may be located at or near a bend in the housing, and/or be at or about at a 45° angle relative to the optical axis of the light entering the interface end of the housing. In another embodiment, the mirror may be pre-assembled and/or pre-machined. Examples of locations and/or positions of the mirror are shown by mirror 140 in FIGS. 1A and 2A.

Referring back to FIG. 4, at 440, an eyepiece (which may be pre-assembled) is permanently or detachably connected to the viewing end of the viewing housing. The eyepiece may comprise a barrel, one or more adjustable and/or focusing lenses, an eye lens, and/or a cup. In further embodiments, the eyepiece may further comprise a diopter adjustment and/or aperture. The eyepiece may have a diameter of 20 mm-30 mm. The lens(es) may be concave, convex, or any combination thereof. In some embodiments, the eyepiece may be detachably connected to the housing a quick release mechanism, a groove and O-ring mechanism, a notch-and-bearing mechanism, complementary thread(s) and groove(s) on the housing and eyepiece, and/or a slidable (e.g., tongue-and-groove) connection to the housing. In another embodiment, the eyepiece may comprise a mechanism for attaching a camera and/or computer display. In another embodiment, the eyepiece may be formed inside the housing. For example, the eyepiece may be formed inside the housing by permanently connecting one or more lenses, an eye lens, and/or a cup to the housing.

It will be readily understood by those skilled in the art that the components of the rotatable viewing device are aligned to allow light entering an interface end of the housing to exit at a viewing end of the housing. For example, the location and/or angle of the mirror inside the housing may be any location and/or angle that ensure good viewing characteristics of an object when viewed through the eyepiece. In another example, the length and/or diameter of the one or more sections of the housing may vary depending on the viewing characteristics of the eyepiece (e.g., the focal length and/or diameter of the eyepiece) and vice versa. In various embodiments, alignment of the optical components of the rotatable viewing device may generally involve aligning the components with each other (e.g., an adjacent optical component) during assembly of the rotatable viewing device, and then having a final alignment of all components once all of the optical components have been mounted or affixed within the housing. At 450, the method ends.

An Exemplary Method of Using a Rotatable Viewing Device

The present invention further relates to method of using a rotatable viewing device. Specifically, the method of using the rotatable viewing device may comprise aligning an optical measuring instrument comprising the rotatable viewing device with an object, rotating the viewing device to a position allowing a user to view the object using the viewing device, and taking one or more measurements of the object using the optical measuring instrument.

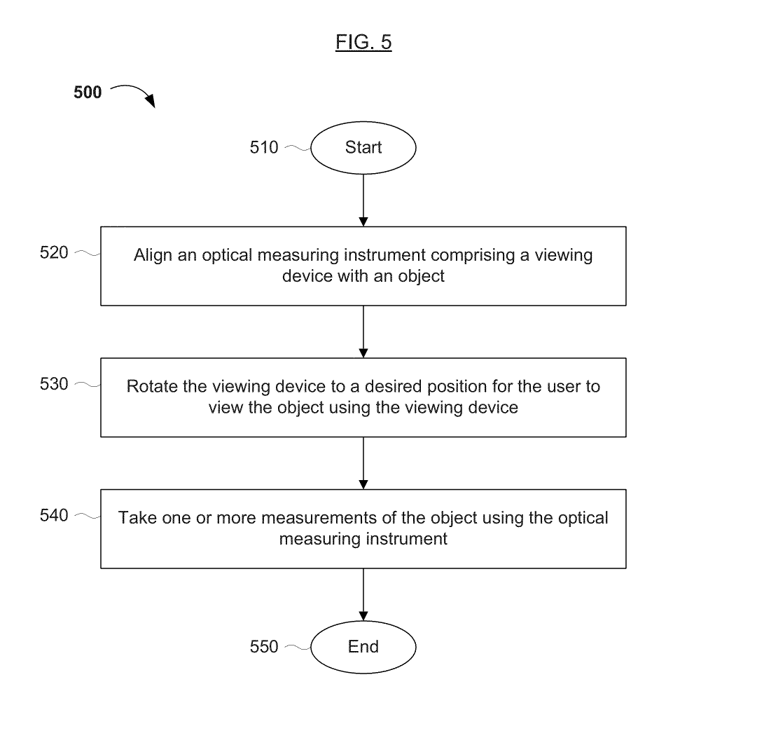

Flow chart 500 of FIG. 5 illustrates a method of using a rotatable viewing device according to the present invention. In one embodiment, the rotatable viewing device can be detachably connected to the optical measuring instrument. The method may begin at 510, and at 520, the method comprises aligning an optical measuring instrument comprising the rotatable viewing device with an object. In various embodiments, the optical measurement instrument may comprise any instrument capable of taking optical measurements (e.g., a photometer, colorimeter, spectrophotometer, or spectroradiometer). The object may be any object on which the user wants to obtain measurements. For example, the object may be a manufactured object, or a chemical gas, solid (e.g., powder) and/or solution. Examples of specific objects may include manufactured objects that may have one or more labels, inks, or attachments thereon, chemical or material samples, environmental samples (e.g., water and/or soil), medical samples (e.g., blood), textiles, precious stones, LCD or LED displays, etc. Alignment of the optical measuring instrument may be done in any manner for subsequently obtaining one or more measurements of the object. For example, alignment of the optical measuring instrument may include adjusting the distance between the optical measuring instrument and the object, the orientation of the optical measuring instrument relative to the object (and/or vice versa), and/or the ambient conditions (e.g. light and/or temperature) the optical measuring instrument and/or the object.

In one embodiment, the method may include rotating the viewing device to a desired position enabling the user to view the object, and optionally, facilitating alignment of the optical measuring instrument with the object. For example, the user may rotate the viewing device to a position where the user can view the object, and then align the object and/or the optical measuring instrument according to the user's view through the viewing device.

At 530, the viewing device may be rotated any number of degrees that allow a user to view the object using the viewing device. For example, referring to FIG. 1A, the upper section 170 of viewing system 100 (e.g., the viewing device) may be rotated one or more of a plurality of predetermined numbers of degrees in a plane parallel or orthogonal to the optical measuring instrument 110 about rotating joint 160. The user may rotate the viewing device to any position that is accessible, convenient, comfortable and/or desirable for the user. In various embodiments, at least one of the one or more rotatable joints or connections has soft stops at predetermined degree values and/or angles.

At 540, the optical measuring instrument may take one or more measurements of the object. For example, the optical measuring instrument may take one or more measurements relating to color matching and/or calibration, colorimetry, spectrophotometry, etc. of the object. In one embodiment, the optical measuring instrument is a colorimeter capable of measuring the wavelength and intensity of electromagnetic radiation (e.g., light). In a further example, the optical measuring instrument is a spectroradiometer capable of measuring the radiance (e.g., intensity) and/or irradiance of light. At 550, the method ends. As will be readily understood by one skilled in the art, the flow 500 can loop any number of times through steps 530 and 540.

### CONCLUSION/SUMMARY

Thus, the present invention provides for moveable and/or rotatable viewing systems used with optical measuring instruments. The present viewing system advantageously provides a viewing system that can freely rotate to enable observation of an image or object under inspection from substantially any angle. The present invention reduces problems associated with conventional viewing systems and therefore enjoys particular advantages in measuring instruments (e.g., optical measuring instruments). The present invention also concerns methods for manufacturing and using a viewing system according to the present invention.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

What is claimed is:

1. A viewing device comprising:
a) a housing, having an interface end opposite a viewing end, and configured to have one or more bends between the interface end and the viewing end;
b) a mirror in the housing;
c) one or more rotatable joints or connections allowing at least part of the housing to be rotated in a plane parallel or orthogonal to an optical axis of an apparatus to which the viewing device interfaces at the interface end; and
d) an eyepiece, located at or near the viewing end.

2. The viewing device of claim 1, wherein the housing has a cavity and a cylindrical, rectangular or oval shape.

3. The viewing device of claim 1, wherein the mirror is at or near one of the one or more bends in the housing.

4. The viewing device of claim 3, wherein at least one bend in the housing has an angle of about 90°.

5. The viewing device of claim 3, wherein the mirror has about a 45° angle relative to the optical axis of the light entering the interface end of the housing.

6. The viewing device of claim 1, wherein the mirror is aligned to allow light entering the interface end to exit at the viewing end.

7. The viewing device of claim 1, wherein the eyepiece further comprises an attachment mechanism adapted to attach a camera and/or a computer display to the viewing system.

8. The viewing device of claim 1, wherein the one or more rotatable joints or connections further allows at least part of the housing to be rotated in a plane perpendicular to the optical axis of the apparatus.

9. The viewing device of claim 1, wherein at least one of the one or more rotatable joints or connections has soft stops at predetermined values and/or angles.

10. The viewing device of claim 9, wherein the soft stops are at increments of 360°/n relative to the optical axis of the apparatus, where n is an integer of 4 to 24.

11. The viewing device of claim 1, wherein the housing has at least two bends, and the viewing system further comprises a second mirror in, at, or near a second one of the at least two bends.

12. The viewing device of claim 11, wherein the second mirror comprises a pentaprism.

13. The viewing device of claim 11, wherein the housing has (i) a first section substantially perpendicular to the apparatus, and (ii) a second section that rotates in a plane substantially perpendicular to the apparatus.

14. The viewing device of claim 13, wherein at least one of the one or more rotating joints is between the angled mirror and the second mirror.

15. A viewing system comprising,
a) the viewing device of claim 1; and
b) an optical measuring instrument attached at the interface end of the viewing device.

16. The viewing device of claim 15, wherein the optical measuring instrument comprises a partially reflecting mirror having one or more apertures therein.

17. The viewing device of claim 15, wherein the optical measuring instrument comprises a photometer, colorimeter or spectroradiometer.

18. A method of making a viewing device, comprising:
a) forming a housing having one or more bends and one or more rotatable joints or connections;
b) attaching a mirror in the housing at or near one of the one or more bends;
c) aligning the mirror and any other optical components in the housing to allow light entering an interface end of the housing to exit at a viewing end of the housing and
d) permanently or detachably connecting an eyepiece to the viewing end of the housing.

19. A method of viewing an object, comprising:
e) aligning an optical measuring instrument comprising a viewing device with an object;
f) rotating the viewing device to a position allowing a user to view the object using the viewing device; and
g) taking one or more measurements of the object using the optical measuring instrument.
